(19) United States
(12) Patent Application Publication
(10) Pub. No.: US 2002/0170777 A1
(43) Pub. Date: Nov. 21, 2002

(54) Retrievable webbing anchor system (the slick!)

(76) Inventor: Matt Todd Moore, Moab, UT (US)

Correspondence Address: MATT T. MOORE, PO BOX 1342, MOAB, UT, 84532, US

(21) Appl. No.: 10/127,908

(22) Filed: Apr. 22, 2002

Related U.S. Application Data
(60) Provisional application No. 60/284,903, filed on Apr. 20, 2001.

(51) Int. Cl. A62B 1/16

(52) U.S. Cl. 182/9

(57) ABSTRACT

This invention is a means for securely connecting a loop of webbing around an object then providing for the release and retrieval of the webbing from a remote location using a small pull cord. The primary application for the invention is rappelling. Rock climbers and canyoneers typically need to leave behind equipment after they complete a rappel. With this invention, all equipment associated with rappelling, including webbing used to attach a rope to an anchor, can be retrieved. This saves the rappeller money, as well as satisfy public land managers (ie, National Park Service) who are increasing becoming intolerant of “fixed” rappel anchors left behind by rappellers.

### CROSS REFERENCE TO RELATED APPLICATIONS

A provisional patent application was filed for this invention on Apr. 20, 2001. Application No. 60/284,903.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

This invention is a means for securely connecting a loop of webbing around an object then providing for the release and retrieval of the webbing from a remote location using a small pull cord. This cord, called a “retrieval” cord, can be hundreds of feet long or longer. No matter the distance, the design of the invention ensures that the force of pull required to release the loop of webbing is small. A built in safety mechanism ensures that the loop of webbing will not be disconnected with the retrieval cord while the webbing is under tension.

While this invention can be used in a variety of applications, it is very well suited for the retrieval of rappelling equipment (ie, for rock climbing, canyoneering, etc).

One of the current standard techniques for rappelling involves using an object such as a tree or rock as an anchor for securing a rappel rope. A loop of webbing, with a small metal ring (called a rappel ring) threaded through the webbing, is tied around the object. A rope is then run through the metal ring such that the mid-point of the rope is resting on the ring. This results in two strands of rope of equal length running to the ground. A person (the rappeller) then attaches a rappel device to both strands of rope on opposite sides of the rappel ring and then rappels to the ground. Once safely on the ground, the rappeller disconnects their rappel device. Then they pull one strand of the rope so that the rope is pulled through the rappel ring that is threaded through the webbing and the rope is retrieved.

One problem with this technique is that, although the rope is successfully retrieved, the webbing and rappel ring remain attached to the anchoring object above. This is a problem for a several reasons.

First, and perhaps most important, is that in many areas where rappelling occurs the abandonment of webbing and rings for rappel anchors is not allowed. Several parks managed by the National Park Service (NPS) in the United States no longer allow for the placement of “fixed” anchors. Fixed anchors are now commonly viewed as visual intrusions on the natural landscape. Land managers of the NPS consider abandoned webbing to be fixed anchors since rappellers do not retrieve them once they've completed their rappel. Other land managers, including the Bureau of Land Management (BLM) and the National Forest Service (NFS) are increasing their restrictions on the placement of fixed anchors. The need for a reliable anchoring method for rappellers which avoids the abandonment of webbing is becoming more important. This invention will help climbers and canyoneers continue their activities in many of these areas while still respecting the new prohibitions placed by the land managers.

Second, even in those areas where fixed anchors are allowed, rappellers may be reluctant to abandon webbing and rappel rings since they are costly. Rappel rings are $2.50 to $3.00 per ring and webbing is $.20 to $.30 per foot. Since two rappel rings are commonly used for each anchor, the cost for a typical rappel anchor from a tree in a canyon is between $6.00 to $10.00 or more. This invention will help climbers and canyoneers avoid leaving behind costly equipment.

Third, there are several different techniques that rappellers are currently using which avoid the abandonment of webbing and rappel rings though these methods are frowned upon. One such technique is to run the rope directly around a tree instead of through rappel rings. Once on the ground, the rappeller pulls one strand of the rope so that the rope is pulled around the tree. This technique scars the bark of the tree and over time will kill the tree. Along the same lines, rappellers will sometimes run the rope directly through a natural opening in a rock instead of through rappel rings. When the rappeller pulls the rope through the rock opening to retrieve it the rope will create unsightly rope “grooves” in the rock. These techniques also damage the rope since the tree bark and gritty rock can easily abrade the rope. This invention helps avoid the scarring of trees and rocks that develop from such techniques, as well as avoid abrasion to the rope. Other techniques are also employed, including the Macrame Knot and Retrievable Webbing. These techniques work, but do have their limitations.

The main benefit of this invention is that a rappeller can easily retrieve the webbing used to anchor the rappel rope to an object such as a tree or rock. The design of the invention especially allows for an easy release and retrieval of webbing anchored to objects that are located far away from the cliff that is being rappelled. We have used this invention to anchor to, rappel from and release the webbing from objects that are over three hundred feet back from the rim of the cliff being rappelled. This is a significant improvement over the aforementioned Macrame Knot and Retrievable Webbing techniques since they are only reliable when used with anchors that are located relatively close to the cliff face. On some cliffs where the only potential anchor is located far from the rim of the cliff, rappellers have installed metal bolts from which to attach their webbing and ropes. These bolts, of course, are considered fixed anchors by land managers and are not allowed in some areas. Even in areas where bolts are allowed by land managers, the local bolting “ethics” espoused by local climbers and canyoneers effectively prohibit the placement of bolts.

Furthermore, the invention's mostly metal-free design makes it suitable for safely retrieving gear from rappels that are several hundred feet or more in height. If a metal retrievable device were used from such heights, the metal may be damaged when it hits the ground upon retrieval. Webbing typically sustains no damage regardless of the height it is dropped.

### SUMMARY OF THE INVENTION

This invention is a means for securely connecting a loop of webbing around an object then providing for the release and retrieval of the webbing from a remote location using a small pull cord. This cord, called a “retrieval” cord, can be hundreds of feet long or longer. No matter the distance, the design of the invention ensures that the force of pull required to release the loop of webbing is small. A built in safety mechanism ensures that the loop of webbing will not be disconnected by the retrieval cord while the webbing is under tension.

While this invention can be used in a variety of applications, it is very well suited for the retrieval of rappelling equipment (ie, for rock climbing, canyoneering, etc). A rope can be tied into the loop of webbing and used for rappelling by climbers and canyoneers.

The invention is made almost entirely of webbing. Its design makes it possible to release the connected loop of webbing with a pull of only a pound or two of force on the retrieval cord. However, a built in safety mechanism ensures that while the anchor webbing is tensioned, for example when a rappeller is hanging on the rope, the retrieval cord cannot be pulled to disconnect the loop of webbing. Only when the rappeller is safely on the ground, and with the rope unweighted, can the retrieval cord be pulled to disconnect the loop of webbing.

The invention can be used to anchor webbing around trees, boulders, rock arches, bolt hangers, ice columns, rock/snow/sand bollards, logjams in canyons or anything else that can be slung with webbing.

### BRIEF DESCRIPTION OF THE DRAWING

FIG. 1 is an overall view of the mechanism.

FIG. 2 is a detailed view of the releasing end of the mechanism when it is engaged.

FIG. 3 is a detailed view of the built in safety and non-releasing end of the mechanism when engaged. Mechanism 1, within which the built in safety is internally housed, has been removed in this drawing to facilitate viewing of built in safety.

### DETAILED DESCRIPTION

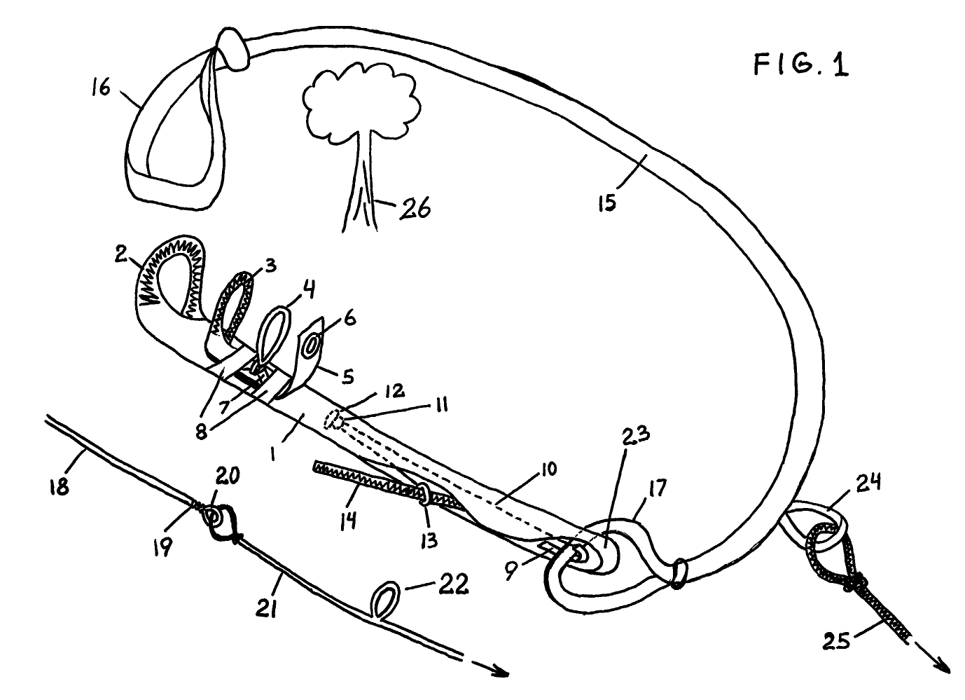

FIG. 1 shows the embodiment of the overall mechanism. The body of the mechanism 1 is comprised of webbing that is doubled over and stitched together. This creates a webbing “sandwich” within which houses the safety system comprised of trigger loop 9, trigger cord 10, directional ring 11, directional ring attachment tab 12, safety tab ring 13 and safety tab 14 which is made of flexible webbing. The releasing end of the doubled webbing is sewn into a major loop 3. The non-releasing end is sewn into a tie-in loop 23.

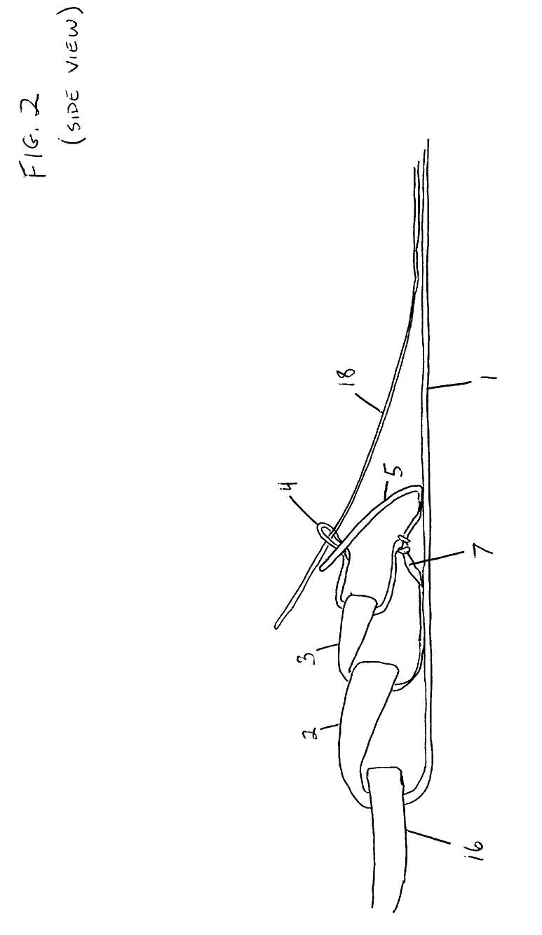

FIG. 2 shows the releasing end of the mechanism when it is engaged. To engage the releasing end, a loop of webbing 16 is threaded over major loop 2. Minor loop 3 is then threaded through major loop 2. The closing loop 4 is then threaded through minor loop 3. The end of closing loop 4 is finally threaded through closing grommet 6 located on the closing tab 5. The closing cable 18 is then threaded through closing loop 4 as it comes out of closing grommet 6. This secures the releasable loops of webbing together. Other components of the releasing end consist of closing loop attachment webbing 7 and two pieces of webbing 8 (FIG. 1) used to stitch in place minor loop 3, closing loop attachment webbing 7 and closing tab 5.

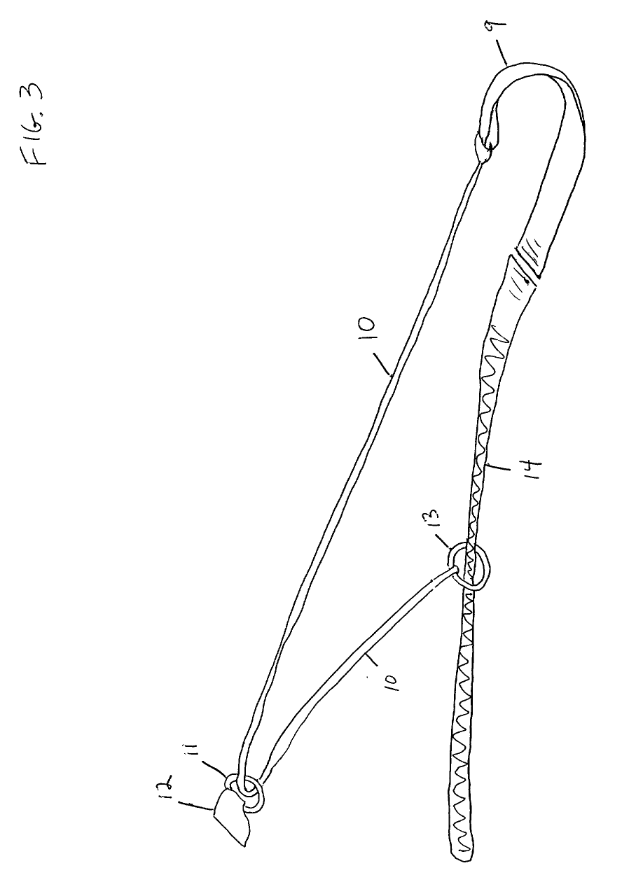

FIG. 3 shows the built in safety and non-releasing end of the mechanism when engaged. A loop of webbing 17 at the end of webbing 15 (typically 1″ tubular webbing) is tied through both tie-in loop 23 and the trigger loop 9. When loop 16 and loop 17 of webbing 15 are wrapped around anchor object 26 (FIG. 1) and engaged into the mechanism, a completed loop of webbing is made into which rope 25 can be tied into rope tie-in loop 24. The rappeller can now attach to rope 25 and descend.

We claim:

1) A webbing apparatus which is used to securely connect two ends of webbing around an object and provide for the release and retrieval of the webbing from a remote location, comprising:
a. A series of sewn webbing loops on the releasable end,
b. a built in safety mechanism on the non-releasable end and
c. a cable which both secures the said series of sewn webbing loops together and provides for their release.
